(19) United States
(12) Patent Application Publication
(10) Pub. No.: US 2025/0174694 A1
(43) Pub. Date: May 29, 2025

(54) METHODS FOR FORMING AN ELECTROCHEMICAL DEVICE AND RELATED ELECTROCHEMICAL DEVICES

(71) Applicant: Battelle Energy Alliance, LLC, Idaho Falls, ID (US)

(72) Inventors: Wei Wu, Idaho Falls, ID (US); Dong Ding, Idaho Falls, ID (US); Zeyu Zhao, Idaho Falls, ID (US)

(21) Appl. No.: 18/960,952

(22) Filed: Nov. 26, 2024

Related U.S. Application Data
(60) Provisional application No. 63/602,818, filed on Nov. 27, 2023.

(51) Int. Cl. H01M 8/1253; H01M 8/12; H01M 8/126

(52) U.S. Cl. CPC H01M 8/1253; H01M 8/126; H01M 2008/1293; H01M 2300/0074; H01M 2300/0094

(57) ABSTRACT

A method for forming an electrochemical device includes forming a first electrolyte layer on a first electrode. A second electrolyte layer is formed on the first electrode, the first electrode positioned between the first electrolyte layer and the second electrolyte layer. A chemical composition and a thickness of the first electrolyte layer and the second electrolyte layer are substantially the same. The method includes heating the first electrolyte layer and the second electrolyte layer and removing the first electrolyte layer. A second electrode is formed on the second electrolyte layer; and the second electrode is heated to form an electrochemical device.

### CROSS-REFERENCE TO RELATED APPLICATION

This application claims the benefit under 35 U.S.C. § 119(e) of U.S. Provisional Patent Application Ser. No. 63/602,818, filed Nov. 27, 2023, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to electrochemical devices. In particular, embodiments of the disclosure relate to methods for forming an electrochemical device such as a planar fuel cell.

### BACKGROUND

As the world transitions to a low-carbon economy, the proton conducting electrochemical cell (PCEC) has emerged as an attractive reversible energy conversion device. It may generate electricity by using hydrogen as a fuel in a fuel cell mode and may also produce hydrogen fuel reversibly by using steam in an electrolysis mode. The PCEC operates at intermediate temperatures due to its protonic ion conductivity and activation energy of ion conduction within a range of from about 400° C. to about 700° C., which is comparable to that of the oxygen-conducting electrochemical cell operating at from about 700° C. to about 850° C. Previously, an electrode-supported planar structure was employed in a PCEC. Barium-based oxides, such as BaZr_{0.4}Ce_{0.4}Y_{0.1}Yb_{0.1}O₃(BZCYYb) and BaZr_{0.5}Y_{0.2}O_{3-δ} (BZY), are known proton-conducting ceramic materials with an ABO₃ perovskite structure. These materials may provide high protonic conductivity and chemical stability in steam and carbon dioxide atmospheres. With advancements in cathode materials and microstructure, the development of PCECs has progressed, enabling operation at temperatures below about 500° C.

However, performance degradation may arise from strain induced by one or more of differences in the thermal expansion coefficient (TEC) of the fuel cell materials and temperature gradients. Prior methods for addressing the TEC mismatch in solid oxide electrolyzer manufacturing include using a buffer layer between the adjunct components to compensate for the differences in TEC or including a counter layer on the surface to balance the stress mismatch. By inclusion of the buffer layer or counter layer, the stress build-up may be absorbed and the mechanical integrity of the cell may be improved. However, this may introduce process complexity and additional components to the fuel cell. Prior methods included fabricating 5×5 cm² BaCe_{0.55}Zr_{0.3}Y_{0.15}O_{3-δ} (BCZY3)-based protonic ceramic fuel cells with a power density of up to 20.8 W per single cell at 600° C. To achieve minimal variation in the TEC between the anode and electrolyte, compositionally uniform granules were utilized during the spray drying process to prepare the anode support layer. However, this method may not be suitable for mass production.

### BRIEF SUMMARY

A method for forming an electrochemical device is disclosed comprising forming a first electrolyte layer on a first electrode and forming a second electrolyte layer on the first electrode, the first electrode positioned between the first electrolyte layer and the second electrolyte layer, and a chemical composition and a thickness of the first electrolyte layer and the second electrolyte layer being substantially the same. The method comprises heating the first electrolyte layer and the second electrolyte layer, removing the first electrolyte layer, and forming a second electrode on the second electrolyte layer. The method also comprises heating the second electrode to form an electrochemical device.

Also disclosed is a method for forming a planar proton conducting electrochemical cell comprising forming a first electrolyte layer on an anode layer and forming a second electrolyte layer on the anode layer, the anode layer positioned between the first electrolyte layer and the second electrolyte layer. A chemical composition and a thickness of the first electrolyte layer and the second electrolyte layer are substantially the same. The method comprises heating the first electrolyte layer and the second electrolyte layer, removing the first electrolyte layer, forming a cathode layer on the second electrolyte layer, and heating the cathode layer to form a planar proton conducting electrochemical cell.

Also disclosed is a planar electrochemical device comprising an electrolyte layer on a first electrode and a second electrode on the electrolyte layer, the electrolyte layer positioned between the first electrode and the second electrode. The electrochemical cell exhibits a substantially flat surface.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a schematic illustrating a prior art method for forming a half-cell and a method for forming a half-cell in accordance with embodiments of the disclosure.

FIG. 2 is a simplified cross-sectional view of an electrochemical cell in accordance with embodiments of the disclosure.

FIG. 3A is an X-ray diffraction pattern (XRD) graph showing intensity (arbitrary unit (a.u.), y-axis) versus X-rays observed at a 20° diffraction angle (x-axis) for BaCe_{0.4}Zr_{0.4}Y_{0.1}Yb_{0.1}O₃(BZCYYb) powder sintered at 1400° C. for 10 hours and BZCYYb electrolyte surface sintered at 1470° C. for 5 hours.

FIG. 3B is an XRD graph showing intensity (arbitrary unit (a.u.), y-axis) versus X-rays observed at a 20° diffraction angle (x-axis) for PrNi_{0.7}Co_{0.3}O_{3-δ} (PNC) powder synthesized by a glycine-citric acid combustion method.

FIG. 4A is a top view of a half-cell prepared in accordance with embodiments of the disclosure (cell on left of FIG. 4A) and a half-cell prepared in accordance with a prior art method (cell on right of FIG. 4A).

FIG. 4B is a top view of a 5×5 cm² half-cell prepared in accordance with embodiments of the disclosure (cell on left of FIG. 4B) after sintering at 1470° C. for 5 hours and a 5×5 cm² half-cell prepared in accordance with a prior art method (cell on right of FIG. 4B) after sintering at 1470° C. for 5 hours.

FIG. 4C is a front view of a half-cell prepared in accordance with embodiments of the disclosure (cell on left of FIG. 4C) and a half-cell prepared in accordance with a prior art method (cell on right of FIG. 4C).

FIG. 4D is a front view of a 5×5 cm² half-cell prepared in accordance with embodiments of the disclosure (cell on left of FIG. 4D) after sintering at 1470° C. for 5 hours and a 5×5 cm² half-cell prepared in accordance with a prior art method (cell on right of FIG. 4D) after sintering at 1470° C. for 5 hours.

FIG. 4E is a three-dimensional height profiling map of a half-cell prepared in accordance with embodiments of the disclosure.

FIG. 4F is a three-dimensional height profiling map of a half-cell prepared in accordance with a prior art method.

FIG. 5A is a power density graph showing voltage (V, y-axis) versus current density (A cm², x-axis) using humidified (3% H₂O) H₂ as fuel and dry air as oxidant for a fuel cell prepared in accordance with embodiments of the disclosure.

FIG. 5B is a power density graph showing voltage (V, y-axis) versus current density (A cm², x-axis) using humidified (3% H₂O) H₂ as fuel and dry air as oxidant for a fuel cell prepared in accordance with a prior art method.

FIG. 5C is an impedance spectra graph showing —Z″ (capacitive behavior or response to changes) (Ω cm², y-axis) versus Z′ (resistive behavior or total system resistance, including material and electrolyte resistance) (Ω cm², x-axis) for a fuel cell prepared in accordance with embodiments of the disclosure.

FIG. 5D is an impedance spectra graph showing —Z″ (Ω cm², y-axis) versus Z′ (Ω cm², x-axis) for a fuel cell prepared in accordance with a prior art method.

FIG. 5E is a graph showing current density (ampere (A) cm⁻², y-axis) versus time (hours, x-axis) at a constant voltage 0.7 V at 600° C. for a fuel cell prepared in accordance with embodiments of the disclosure.

FIG. 6A is a scanning electron micrograph (SEM) image of a cross section of a half-cell prepared in accordance with a prior art method.

FIG. 6B is a SEM image of a cross section of a half-cell prepared in accordance with embodiments of the disclosure.

FIG. 6C is a SEM image of an electrolyte and anode support layer of a half-cell prepared in accordance with embodiments of the disclosure.

FIG. 6D is a SEM image of an anode support layer half-cell prepared in accordance with embodiments of the disclosure after removing one side of electrolyte.

FIG. 6E is a SEM image of a cross section of a fuel cell prepared in accordance with embodiments of the disclosure showing the cathode, electrolyte, and anode support layer before a cell performance test.

FIG. 6F is a SEM image of a cross section of a fuel cell prepared in accordance with embodiments of the disclosure showing the cathode, electrolyte, and anode support layer after a cell performance test.

FIG. 6G is an energy dispersive X-ray image (EDX) of an electrolyte surface of a half-cell prepared in accordance with embodiments of the disclosure.

### DETAILED DESCRIPTION

The illustrations presented herein are not actual views of any fuel cell, or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any electrochemical reactor when utilized in a conventional manner. Furthermore, these terms may refer to an orientation of elements of any electrochemical membrane reactor as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

Proton-conducting electrochemical cells (PCECs) have the potential to be highly efficient in converting energy, as they can generate electricity using hydrogen or hydrocarbon fuels or may produce hydrogen fuel by using steam in an electrolysis mode. However, the commercialization of PCECs has been limited due to lower-than-expected performance and difficulties in scaling up the technology. One of the reasons for this may be that micro-defects may be induced during conventional fabrication processes.

Electrochemical cells, such as PCECs, having a low degradation rate during constant current density operation and the ability to withstand temperature changes are desired. The temperature changes may include thermal cycling, which involves exposure to extreme temperature differentials from the operating temperature to ambient temperature (which is close to room temperature). Performance degradation resulting from the thermal cycling may be primarily mechanical in nature and may arise from strains induced by one or more of differences in thermal expansion coefficient (TEC) of the fuel cell materials and temperature gradients. The mismatch of the thermal expansion coefficient of an electrolyte of a PCEC and anode support layer may induce residual stress during sintering and may result in deformation of the electrochemical cells. The uniformity or flatness of planar solid oxide cells may impact one or more of the residual stress induced during fabrication and the thermal cycling durability of the electrochemical cells. Deformation or non-flatness may result in variations in the thickness of the electrochemical cell at different locations, which may lead to differences in the thermal expansion coefficients and may subsequently result in residual stress within the electrochemical cell. This residual stress may place a burden on the electrochemical cell mechanical integrity. Additionally, the deformation may exacerbate stress and deformation during thermal cycling, potentially causing electrochemical cell cracks or other damage that may result in electrochemical cell or stack failure. Therefore, it is desirable to achieve and maintain flatness in the electrochemical cell.

In embodiments of the disclosure, methods are provided that employ a symmetric electrolyte to form an electrochemical half-cell to compensate for the asymmetric distribution of thermal stresses during the half-cell fabrication process. The method may be utilized to fabricate anode-supported PCECs with sizes up to about 10×10 cm². The electrochemical performance of the electrochemical cells prepared in accordance with embodiments of the disclosure may be comparable to high quality PCECs and show improved thermal cycling tolerance over conventional PCECs that lack the symmetric electrolyte.

In embodiments of the disclosure, a stress compensation method for preparing an electrochemical device (e.g., a planar electrochemical cell, a planar PCEC, a planar oxygen-ion-conducting electrochemical cell, or a planar solid state lithium ion battery) comprises applying symmetric electrolyte layers to a first electrode layer (e.g., an anode, an anode support layer (ASL)) during the fabrication of planar PCECs half-cells. The electrolyte layers are considered “symmetric” because first and second electrolyte layers comprising one or more of substantially the same composition, substantially the same thickness, and substantially the same coefficient of thermal expansion, are formed on either side of the anode support layer during the half-cell fabrication. The anode support layer may be between the first electrolyte layer and the second electrolyte layer. The first electrolyte layer may subsequently be removed from the half-cell and a second electrode layer (e.g., a cathode) may be formed on the second electrolyte layer to form a full cell (e.g., a complete electrochemical cell), such as a PCEC. In some embodiments, the anode is a hydrogen (H₂) electrode and the cathode is an oxygen (O₂) electrode.

The method may result in a high-performing PCEC with improved thermal cycling durability. The double-sided electrolyte configuration utilized for forming the half-cell may provide a flat sintered electrochemical cell having a high chemical purity. The stress compensation method in accordance with embodiments of the disclosure may provide improved manufacturability and performance of the electrochemical device prepared by the method, including improved manufacturability and performance of proton conducting electrochemical cells, oxygen ion conducing electrochemical cells, solid oxide cells, solid state lithium ion batteries, and other types of solid materials prepared using processes which may introduce thermal stress.

In embodiments of the disclosure, a method for forming an electrochemical device is described, the method comprising forming a first electrolyte layer on a first electrode (e.g., an anode support layer) and forming a second electrolyte layer on the first electrode, with the first electrode (e.g., anode support layer) between the first electrolyte layer and the second electrolyte layer. A chemical composition and a thickness of the first electrolyte layer and the second electrolyte layer may be substantially the same. The method further comprises heating (e.g., sintering) the first electrolyte layer and the second electrolyte layer to form the half-cell.

The method further comprises removing the first electrolyte layer from the half-cell, forming a second electrode layer (e.g., a cathode layer) on the second electrolyte layer, and heating (e.g., sintering) the cathode layer to form an electrochemical device that includes the first electrode layer, the second electrolyte layer, and the second electrode layer.

The method may be employed to form solid materials for any suitable or desired application, such as for applications using high-temperature processes or other processes which may introduce thermal stress. In embodiments of the disclosure, the method comprises forming a first electrolyte layer on a first layer and forming a second electrolyte layer on the first layer, where a chemical composition and a thickness of the first electrolyte layer and the second electrolyte layer are substantially the same; heating the first electrolyte layer and the second electrolyte layer; removing the first electrolyte layer; forming a second layer on the second electrolyte layer; and heating the second layer to form the solid material.

In embodiments of the disclosure, the method comprises forming an electrochemical device. The method may be utilized for forming any suitable or desired electrochemical device. For example, the method may be utilized for forming a proton-conducting electrochemical cell, an oxygen-ion-conducting electrochemical cell, a solid oxide fuel cell, or a solid state lithium ion battery. In further embodiments of the disclosure, the method includes forming a planar electrochemical device, for example, a planar electrochemical cell, such as a planar proton conducting electrochemical cell, a planar oxygen ion conducting electrochemical cell, or a planar solid state lithium ion battery.

The electrochemical device may be an anode supported electrochemical cell. Electrochemical cells employing the anode as a support structure may enable use of a relatively thin electrolyte layer. The anode support layer in such electrochemical cells may comprise an anode material (e.g., nickel) and a support layer material (e.g., a barium based oxide). The anode may, for example, be a barium-based oxide/NiO anode.

An anode support layer of the electrochemical device may include any suitable or desired anode support material and may be selected depending on the type of electrochemical device. The anode support layer may be porous. The anode support layer may include, but is not limited to, a barium-based oxide electrolyte material, a barium-based oxide-NiO material, (e.g., nickel oxide barium carbonate), zirconia, cerium oxide, yttrium oxide, ytterbium oxide, or a combination thereof. In further embodiments of the disclosure, the anode support layer may comprise nickel oxide and one or more of barium, cerium, yttrium, and ytterbium. For example, the anode support layer may comprise a barium based oxide such as BaZr_{0.4}Ce_{0.4}Y_{0.1}Yb_{0.1}O₃ (BZCYYb) or BaZr_{0.5}Y_{0.2}O_{3-δ} (BZY). The anode support layer may be prepared by any suitable or desired method. In embodiments of the disclosure, the anode support layer may be prepared by conventional tape casting methods.

The first electrolyte layer and the second electrolyte layer may each have a chemical composition that is substantially the same and a thickness that is substantially the same. Any suitable or desired thickness may be selected for the first electrolyte layer and the second electrolyte layer provided that the thickness for each layer is substantially the same. In embodiments of the disclosure, the first electrolyte layer and the second electrolyte layer may each have a thickness of from about 1 micrometer to about 100 micrometers, or from about 5 micrometers to about 15 micrometers, with the thickness of the first electrolyte layer and the second electrolyte layer being substantially the same. However, other thicknesses of the first electrolyte layer and the second electrolyte layer may be used, depending on the type of electrochemical cell to be formed.

Any suitable or desired material may be selected for the electrolyte layer provided that the chemical composition for the first electrolyte layer and second electrolyte layer is the same. The chemical composition of the electrolyte material may be selected according to the type of electrochemical device being prepared.

Materials for the first electrolyte layer and the second electrolyte layer may be one or more of ceria, yttrium doped ceria, scandium doped ceria, cerium doped ceria, gadolinium doped ceria, strontium doped ceria, magnesium doped ceria, zirconia, yttrium doped zirconia, scandium doped zirconia, cerium doped zirconia, gadolinium doped zirconia, strontium doped zirconia, magnesium doped zirconia, cerium zirconium oxide, yttrium doped cerium zirconium oxide, scandium doped cerium zirconium oxide, cerium doped cerium zirconium oxide, gadolinium doped cerium zirconium oxide, strontium doped cerium zirconium oxide, magnesium doped cerium zirconium oxide, lanthanum gallate, yttrium doped lanthanum gallate, scandium doped lanthanum gallate, cerium doped lanthanum gallate, gadolinium doped lanthanum gallate, strontium doped lanthanum gallate, and magnesium doped lanthanum gallate, provided the first electrolyte layer and the second electrolyte layer exhibit substantially the same chemical composition.

The electrolyte material for a proton-conducting electrochemical cell may be a perovskite type material having the chemical formula of ABO₃, where A and B are metal cations, such as barium, zirconium, or cerium. The electrolyte material may be a barium-based oxide electrolyte. The electrolyte material may be barium zirconate, a doped derivative of barium zirconate, barium cerate, a doped derivative of barium cerate, a mixed barium zirconium cerium oxide, or a doped derivative of the mixed barium zirconium cerium oxide. The dopant may include, but is not limited to, strontium, lanthanum, calcium, yttrium, ytterbium, iron, cobalt, scandium, zinc, or hafnium. The first electrolyte layer and the second electrolyte layer may be formed of and include one or more of barium zirconate, yttrium doped barium zirconate, ytterbium doped barium zirconate, iron doped barium zirconate, cobalt doped barium zirconate, samarium doped barium zirconate, zinc doped barium zirconate, hafnium doped barium zirconate, strontium doped barium zirconate, lanthanum doped barium zirconate, calcium doped barium zirconate, barium cerate, yttrium doped barium cerate, ytterbium doped barium cerate, iron doped barium cerate, cobalt doped barium cerate, samarium doped barium cerate, zinc doped barium cerate, hafnium doped barium cerate, strontium doped barium cerate, lanthanum doped barium cerate, or calcium doped barium cerate, provided the first electrolyte layer and the second electrolyte layer have substantially the same chemical composition.

The electrolyte material for an oxygen-ion-conducting electrochemical cell may be selected from one or more of ceria (cerium (IV) oxide, CeO₂), a doped derivative thereof, zirconia (zirconium dioxide, ZrO₂), a doped derivative thereof, a mixed cerium zirconium oxide, or a doped derivative thereof. The electrolyte material may exhibit a crystal structure of the fluorite type. The dopant may include, but is not limited to, one or more of yttrium, scandium, cerium, or gadolinium. Alternatively, the electrolyte material for the oxygen-ion-conducting electrochemical cell may be lanthanum gallate or a doped derivative thereof. The electrolyte material may exhibit a crystal structure of the perovskite type. The dopant may include, but is not limited to, one or more of strontium and magnesium.

The electrolyte material for a solid-state lithium ion battery may be selected from lithium lanthanum oxide and doped derivatives thereof. The electrolyte may exhibit a crystal structure of the garnet type. The dopant may include, but is not limited to, one or more of niobium, tantalum, barium, and zirconium. In certain embodiments, the electrolyte material for a solid-state lithium-ion battery may be Li₇La₃Zr₂O₁₂.

A method of forming the electrochemical device includes forming the first electrolyte layer and the second electrolyte layer on the first electrode (e.g., anode support layer) by conventional techniques, including, but not limited to, tape casting. For example, the first electrolyte layer and second electrolyte layer may be disposed on either side of the anode support layer and the structure may be heated (e.g., laminated or sintered) to form a half-cell.

The method also includes heating the first electrolyte layer and the second electrolyte layer by conducting a first heating (e.g., sintering) at a first temperature and a second heating (e.g., sintering) at a second temperature where the second temperature is higher than the first temperature. The first temperature may be within a range of from about 600° C. to about 1100° C., such as from about 700° C. to about 1100° C., from about 700° C. to about 1000° C., from about 700° C. to about 900° C., from about 700° C. to about 800° C., from about 600° C. to about 1000° C., from about 600° C. to about 900° C., or from about 600° C. to about 800° C. The second temperature may be within a range of from about 1300° C. to about 1600° C., such as from about 1400° C. to about 1600° C., from about 1400° C. to about 1500° C., or from about 1300° C. to about 1500° C. In embodiments, the first temperature may be from 600° C. to about 800° C., such as about 720° C., and the second temperature may be from about 1400° C. to about 1600° C., such from about 1450° C. to about 1470° C. The first electrolyte layer and the second electrolyte layer may be heated at the first temperature to remove binders and other volatile components of the electrolyte layers, before increasing to the second temperature. The sintering temperature and length of sintering time may depend on the type of material employed for the first electrolyte layer and the second electrolyte layer as is known in the art. In embodiments of the disclosure, sintering the first electrolyte layer and the second electrolyte layer may comprise sintering at a first temperature for a period of from about 1 hour to about 2 hours and a second sintering at a second temperature wherein the second temperature is higher than the first temperature for a period of from about 2 hours to about 6 hours. Heating the first electrolyte layer and the second electrolyte layer may comprise heating with the first electrolyte layer, first electrode, second electrolyte layer buried in electrolyte powder (e.g., immersed in electrolyte powder, covered with electrolyte powder).

A conventional half-cell may include an anode support layer and an electrolyte layer formed on a single side of the anode support layer (termed herein a single-sided electrolyte half-cell or SEHC). In contrast, the method of forming the half-cell in accordance with embodiments of the disclosure may include forming the first electrolyte layer on the anode support layer and forming the second electrolyte layer on the anode support layer, with the anode support layer between the first electrolyte layer and the second electrolyte layer. The first electrolyte layer may be formed on a first side of the anode support layer and the second electrolyte layer may be formed on a second, opposing side of the anode support layer. A chemical composition and a thickness of the first electrolyte layer and the second electrolyte layer are substantially the same. The first electrolyte layer and the second electrolyte layer are sintered, forming a double-sided electrolyte half-cell (DEHC).

Without wishing to be bound by theory, it is believed that the electrolyte/first layer/electrolyte (e.g., electrolyte/anode support layer/electrolyte) configuration (i.e., the symmetric double-sided electrolyte) may result in a half-cell having one or more of a substantially flat surface, a smooth surface, a surface that is substantially free of defects, and a surface that is substantially free of impurities after high temperature sintering. A surface flatness may be described as the variation between the highest and lowest points on a surface, measured in relation to a tolerance zone. In embodiments of the disclosure, the symmetric double-sided electrolyte may result in a half-cell having a flat surface exhibiting a surface variation of less than about 50 micrometers. Preparing the half-cell including the symmetric double-sided electrolyte may protect the physical integrity of the first layer (e.g., first electrode or anode support layer) and may provide a uniform distribution of stress during the half-cell fabrication process. The half-cell having the symmetric double-sided electrolyte on both sides of the anode support layer may also protect the anode support layer from impurities in the process environment and may help the half-cell withstand thermal shrinkage.

The sintering of the first electrolyte layer and the second electrolyte layer may also increase the density of the first electrolyte layer and the second electrolyte layer in the half-cell, which may improve performance of a full cell prepared from the half-cell. Without wishing to be bound by theory, it is believed that any microdefects or deformation initially present in the first electrolyte layer and the second electrolyte layer may be eliminated following the sintering. Since the microdefects or voids are decreased, the resulting full cell may exhibit comparable or better performance than conventional electrochemical cells. The full cell may also be more durable and robust than conventional electrochemical cells.

To prepare a full cell from the half-cell, the method may include removing the first electrolyte layer, forming a second electrode layer (e.g., a cathode layer) on the second electrolyte layer, and sintering the cathode layer to form an electrochemical device that includes the anode support layer, the second electrolyte layer, and the cathode. The first electrolyte layer may be removed by any suitable or desired process including, but not limited to, one or more of chemically removing the first electrolyte layer and physically removing the first electrolyte layer. For instance, the first electrolyte layer may be dissolved using an acidic solution, such as a dilute nitric acid solution. Alternatively, the first electrolyte layer may be removed by chemical mechanical polishing (CMP).

The second layer (e.g., second electrode or cathode layer) may be formed on the second electrolyte layer by conventional techniques. In embodiments of the disclosure, forming a cathode layer comprises one or more of screen printing a cathode layer, painting a cathode layer, or dip coating a cathode layer.

The cathode layer may comprise any suitable or desired material and may be selected according to the type of electrochemical device. In embodiments of the disclosure, forming the cathode layer comprises forming the cathode layer with one or more of praseodymium nickel cobalt, Ba_{0.5}Sr_{0.5}Co_{0.8}Fe_{0.2}O_{3-δ}, PrBaCo₂O_{5+δ}, PrBa_{0.5}Sr_{0.5}Co₂₋ₓFeₓO_{5+δ}, PrBa_{0.5}Sr_{0.5}Co_{1.5}Fe_{0.5}O_{5+δ}, NdBa_{0.5}Sr_{0.5}Co_{1.5}Fe_{0.5}O_{5+δ}, SmBa_{0.5}Sr_{0.5}Co_{1.5}Fe_{0.5}O_{5+δ}, Sm₁₋ₓSrₓCoO_{3-δ}, BaZr_{1-x-y-z}CoₓFe_{y}Y_{z}O_{3-δ}, SrScₓNd_{y}Co_{1-x-y}O_{3-δ}, La₂NiO_{4-δ}, Pr₂NiO_{4-δ}, Gd₂NiO_{4-δ}, Sm₂NiO_{4-δ}, Sm₁₋ₓSrₓCoO_{3-δ}-BZCYYb, Ni-BZCYYb, NiO-BZCYYb, NiO—BaZr_{0.1}Ce_{0.7}Y_{0.2-x}YbₓO_{3-δ}, Ni-BSNYYb, Ni—BaCeO₃, Ni—BaZrO₃, Ni—Ba₂(YSn)O_{5.5}, Ni—Ba₃(CaNb₂)O₉, or a combination thereof, wherein x, y, and z are dopant levels and 6 is an oxygen deficit.

Heating (e.g., sintering the cathode layer) may comprise heating the cathode layer at any suitable or desired temperature for any suitable or desired length of time. Sintering temperature and time may be selected in accordance with the cathode layer material as is known in the art. In embodiments of the disclosure, sintering the cathode layer may comprise sintering at a temperature of from about 700° C. to about 1600° C., such as from about 700° C. to about 1500° C., from about 700° C. to about 1400° C., from about 700° C. to about 1300° C., from about 800° C. to about 1400° C., from about 900° C. to about 1400° C., from about 900° C. to about 1300° C. or from about 900° C. to about 1200° C. In embodiments of the disclosure, sintering the cathode layer may comprise sintering at a temperature of from about 900° C. to about 1200° C. for a period of from about 1 hour to about 3 hours.

In embodiments of the disclosure, the anode support layer comprises one or more of nickel oxide barium carbonate, zirconia, cerium oxide, yttrium oxide, and ytterbium oxide, forming the first electrolyte layer and forming the second electrolyte layer comprises forming the first and second electrolyte layers with one or more of barium carbonate, zirconia, cerium oxide, yttrium oxide, and ytterbium oxide, and forming the cathode layer comprises forming the cathode layer with praseodymium nickel cobalt.

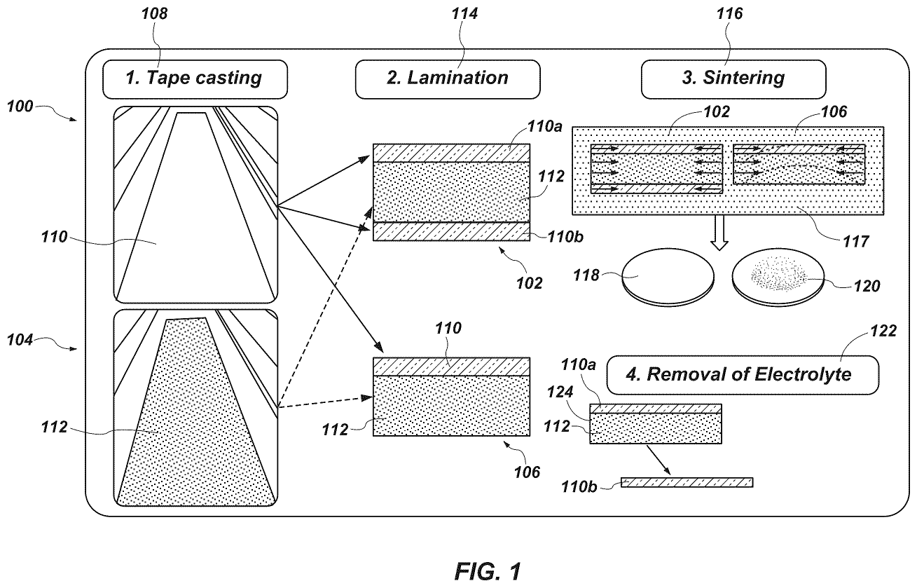

Turning to FIG. 1, a method 100 for forming a double-sided electrolyte half-cell 102 in accordance with embodiments of the disclosure is contrasted with a conventional method 104 for forming a single-sided electrolyte half-cell 106. The method may include tape casting, laminating, sintering to form a half-cell comprising the double-sided electrolyte, and removing one of the electrolyte layers. The method 100 may include tape casting to form an electrolyte film on an anode support layer, laminating, sintering, and removing one of the electrolyte layers. The method 100 and method 104 both include preparing 108 (e.g., tape casting) green tapes of an electrolyte layer 110 (e.g., electrolyte film such as BZCYYb411 electrolyte film) and a hydrogen electrode layer 112 (e.g., a BZCYYb4411+NiO anode support layer). The method 100, in accordance with embodiments of the disclosure, comprises laminating 114 an electrolyte film 110a, 110b on opposite sides of the hydrogen electrode layer 112 to form a double-sided electrolyte half-cell 102. In contrast, conventional method 104 includes laminating 114 an electrolyte layer (e.g., electrolyte film) 110 on one side of hydrogen electrode layer 112 to form a single-sided electrolyte half-cell 106. Lamination for the method in accordance with the disclosure and the conventional method may be performed under temperatures, pressures, and periods of time, as known in the art. In embodiments of the disclosure, lamination may be performed at a temperature of from about 40° C. to about 100° C., at a pressure of from about 1 ton (1,000 kilograms) to about 5 tons (5,000 kilograms), for a period of from about 1 hour to about 6 hours. For example, lamination may be performed at a temperature of about 40° C. and a pressure of about 1.5 tons for a period of about 3 hours or at a temperature of about 70° C. and a pressure of about 2.5 tons for a period of about 3 hours. Heating 116 (e.g., sintering) the laminated double-sided electrolyte cell 102 and laminated single-sided electrolyte cell 106 forms sintered double-sided electrolyte half-cell 118 (e.g., 1-inch button cell) and sintered single-sided electrolyte half-cell 120. During heating 116, the electrochemical cells may be buried in electrolyte powder 117. That is, the electrochemical cells may be immersed in or covered with electrolyte powder such that the electrolyte powder surrounds the electrochemical cells. Thus, in embodiments of the disclosure, sintering the first electrolyte layer 110a and the second electrolyte layer 110b comprises sintering the first electrolyte layer 110a and the second electrolyte layer 110b under an electrolyte powder 117 (e.g., buried in, immersed in, or covered by an electrolyte powder). After forming the sintered double-sided electrolyte half-cell 118, one side of electrolyte film 110b is removed 122 (e.g., removed using a polishing machine) from sintered double-sided electrolyte half-cell 118 to form electrolyte cell 124. Electrolyte cell 124, according to embodiments of the disclosure, and conventional electrolyte cell 120 may then be used to prepare a full cell (e.g., by addition of an oxygen electrode layer).

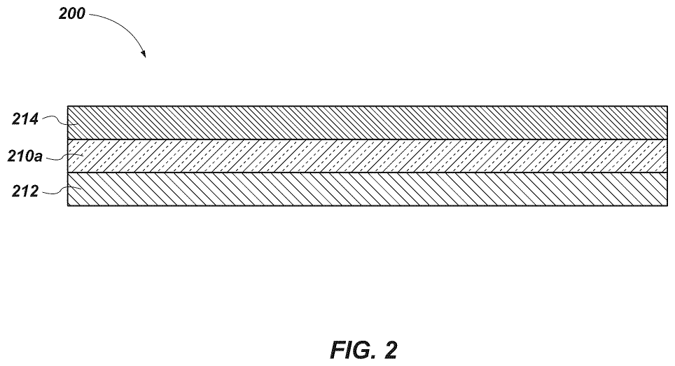

FIG. 2 illustrates a simplified cross-sectional view of an electrochemical cell 200 according to embodiments of the disclosure. The electrochemical cell 200 may include a first electrode 212 (e.g., hydrogen electrode or anode), a second electrode 214 (e.g., an oxygen electrode or cathode), and an electrolyte 210a disposed between the second electrode 214 and the first electrode 212.

The following examples serve to explain embodiments of the disclosure in more detail. These examples are not to be construed as being exhaustive or exclusive as to the scope of the disclosure.

### EXAMPLES

### Example 1

### Material Preparation

BaCe_{0.4}Zr_{0.4}Y_{0.1}Yb_{0.1}O₃(BZCYYb) powders were prepared by a solid state reaction method. Stoichiometric quantities of barium carbonate (BaCO₃, 99% purity, Alfa Aesar), zirconia (ZrO₂, 99% purity, Alfa Aesar), cerium oxide (CeO₂, 99% purity, Alfa Aesar), yttrium oxide (Y₂O₃, 99% purity, Alfa Aesar) and ytterbium oxide (Yb₂O₃, 99% purity, Alfa Aesar) were mixed in ethanol and ball-milled with yttria-stabilized zirconia balls for 24 hours. Then, the homogenous mixture was heated at 120° C. to remove ethanol. The dried powder was first calcined at 1100° C. for 10 hours. After the first calcination, the same milling and drying acts were repeated, and the dried powder was calcinated at 1400° C. for 10 hours to ensure phase formation.

An anode support layer (NiO-BZCYYb) and electrolyte film (BZCYYb) were fabricated by conventional tape casting methods. Commercial powders of NiO (NiO, Alfa Aesar, USA) and a home-made BZCYYb powder were used as raw materials to produce the NiO-BZCYYb anode support layer and the BZCYYb electrolyte film. NiO and BZCYYb powder were first mixed and ball-milled in ethanol and toluene solvents containing fish oil dispersant for 24 hours to break down agglomerates which were present in the powder. Polyvinyl butyral (BUTVAR® B-76 Polyvinyl Butyral, USA) and benzyl butyl phthalate (BBP, SANTICIZER® 5-160) binders were added and ball-milled again for 24 hours to form a homogeneous slurry. Next, the slurry was tape cast using a tape caster with a doctor blade gap of 1.02 mm for the anode support layer. BZCYYb electrolyte film was produced by a similar procedural without NiO and tape cast with a 0.102 mm doctor blade gap. Finally, green NiO-BZCYYb anode support layer tape and white BZCYYb electrolyte film tape was obtained on a polyethylene (PET) carrier film, respectively.

The cathode material, PrNi_{0.7}Co_{0.3}O_{3-δ} (PNC), was synthesized by a glycine-citric acid combustion method. Stoichiometric amounts of Pr(NO₃)₃·6H₂O, Ni(NO₃)₂·6H₂O, and Co(NO₃)₃·6H₂O (Sinopharm Chemical Reagent Co., Ltd) were dissolved in deionized water to form an aqueous solution. Citric acid and glycine (Sinopharm Chemical Reagent Co., Ltd), which act as complexation agents, were then added with a molar ratio of citric acid:glycine:metal of 1:2:1. The mixed solution was stirred and heated until self-combustion occurred. The as-prepared powders were sintered at 1050° C. for 5 hours to obtain fine PNC powders. Finally, a PNC cathode paste was prepared by mixing with 441-thinner at a weight ratio of PNC:thinner of 1:1.5.

### Example 2

Preparation of PCECs with Stress Relief Sintering

### Cell Fabrication

Hydrogen electrode-supported cells were fabricated by a tape-casting process. To prepare green tapes of the hydrogen electrode, NiO and BZCYYb powders were mixed at a 6 to 4 weight ratio by ball milling in ethanol and toluene for 24 hours. Polyvinyl butyral binder (Tape Casting Warehouse, Inc.), butyl benzyl phthalate plasticizer (Tape Casting Warehouse, Inc.) and fish oil dispersant (Tape Casting Warehouse, Inc.) were next added, followed by ball milling for an additional 24 hours to yield the desired slip rheology. Tape casting was performed using a laboratory tape-casting machine. The thickness of the hydrogen electrode green tapes was controlled at about 1 mm after drying at 37.8° C. for 4 hours. Green tapes of electrolyte were prepared similarly with BZCYYb (without adding NiO) and by controlling the thickness to about 0.12 mm (for the 22-μm-thick BZCYYb electrolyte after sintering) or about 0.08 mm (for the 16-μm-thick BZCYYb electrolyte after sintering) after drying. Three pieces of hydrogen electrode green tapes and one piece of electrolyte green tape were laminated by a hot press at 70° C. under 4 tons (4,000 kilograms) for 5 hours. Laminated green tapes were punched with 11-mm ( 7/16-inch) diameter holes and pre-sintered at 920° C. for 3 hours to remove the organics. The co-sintering of the hydrogen electrode-electrolyte bilayer was conducted at T₁=1,400° C. at 5 hours (heating rate 1° C. min⁻¹ to 1,000° C. and 2° C. min⁻¹ to 1,400° C.), followed by a furnace cooling. To treat the surface, 0.3 ml (0.53 ml cm⁻²) of concentrated nitric acid (Alfa Aesar) was dropped on the electrolyte surface of the co-sintered hydrogen electrode-electrolyte bilayer, left for different times ranging from about 1 to about 15 minutes and then washed with deionized water. To fabricate full cells, a slurry of oxygen electrode material was prepared by mixing oxygen electrode powders with ethanol and a TEXANOL™-based binder (ESL ElectroScience) by ball milling and then brush-painting on the electrolyte surface of the co-sintered hydrogen electrode-electrolyte bilayer.

PCFCs/PCECs are conventionally prepared by first co-sintering the hydrogen electrode-electrolyte bilayer at a high temperature T₁, and then screen-printing or painting the oxygen electrode layer, followed by a second sintering at a lower temperature T₂. See conventional method 104 as shown in FIG. 1.

Half-cells were prepared by two different approaches. A conventional procedure was utilized to fabricate a conventional single-sided electrolyte half-cell (SEHC) with a NiO-BZCYYb//BZCYYb configuration by hot laminating the BZCYYb and NiO-BZCYYb tapes under 2.5 tons at 70° C. for 3 hours. The methods, according to embodiments of the disclosure, were utilized to prepare a double-sided electrolyte half-cell (DEHC) by laminating an electrolyte film on both sides of the anode support layer (ASL) tape to get a half-cell configuration comprising a BZCYYb//NiO-BZCYYb//BZCYYb double-sided electrolyte half-cell (DEHC). Then, cells having a diameter of 1-inch (2.54 centimeters) and 5×5 cm² square cells were cut from the tape. The cells were pre-sintered at 720° C. for 3 hours to remove the organics on an Al₂O₃ plate, and the anode-electrolyte bi-layer structure was sintered at 1450° C. for 5 hours in BZCYYb powder to obtain DEHC half-cells having a porous anode support layer sandwiched between dense double-sided electrolyte layers. The DEHC half-cell was prepared for cell electrochemical tests by removing the electrolyte from one side with a polishing machine set at 250 rpm (revolutions per minute) for 2 seconds. Full cells (from the DEHC half-cell) were fabricated by screen printing the PNC paste as a cathode on the remaining electrolyte layer. The final sintering was carried out at 1000° C. for 2 hours. In the same fashion, single cells were fabricated from the conventional SEHC half-cell by screen printing the PNC paste as a cathode on the electrolyte layer.

### Characterization

The as-prepared BZCYYb powder and phase structure of dense BZCYYb electrolyte were characterized by X-ray diffraction (XRD, 2008 Bruker D8). A scanning electron microscope (SEM, JEOL 6700F) was used to observe the electrolyte surface morphology and cell cross section microstructure. The flatness of the cell surfaces were characterized by Wide-Area 3D Measurement System (KEYENCE, VR Series). For fuel cell electrochemical testing, the as-fabricated 1 inch button cell was sealed with ceramic sealant (CERAMABOND™ 552) onto the testing fixture and the electrochemical performances at the fuel cell modes were collected by using an electrochemical workstation (Solartron 1400). Electrochemical impedance spectra (EIS) were measured at open circuit voltage (OCV) with a frequency from 10⁵ to 0.1 Hz and AC amplitude of 20 mV. The long-term stability was examined for 200 hours at a temperature of 600° C. with a fuel cell voltage of 0.7 V. After the electrochemical testing, the microstructure of the button cells was observed using a scanning electron microscope (SEM) in back scattering electron mode.

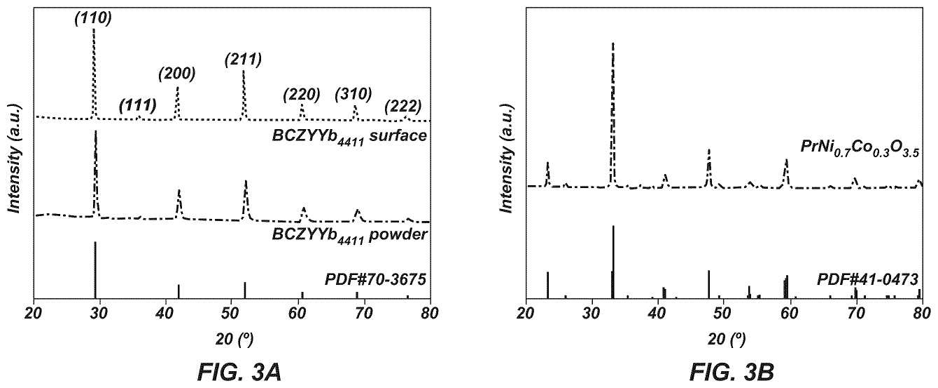

The as-prepared BZCYYb powder and the sintered-electrolyte surface were characterized by XRD. FIG. 3A shows XRD patterns of the BZCYYb powder sintered at 1400° C. for 10 hours and the BZCYYb electrolyte surface sintered at 1470° C. for 5 hours. FIG. 3B shows XRD patters of the PrNi_{0.7}Co_{0.3}O_{3-δ} (PNC) powder synthesized by the glycine-citric acid combustion method. As shown in FIG. 3A, both the BZCYYb powder and the BZCYYb electrolyte surface adopted a cubic crystal structure, which are consistent with literature. XRD patterns of PNC cathode material shown in FIG. 3B showed a single orthorhombic perovskite structure.

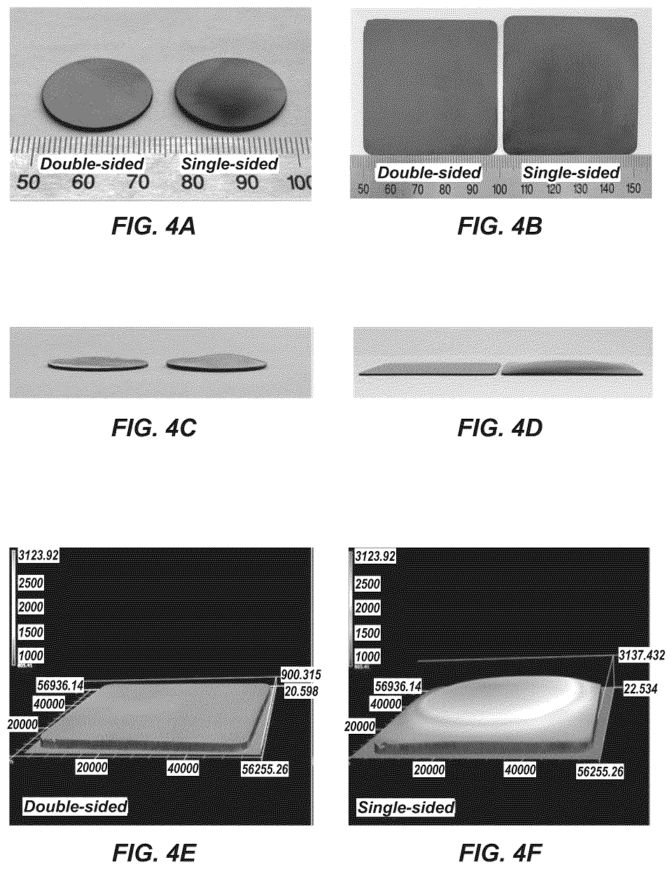

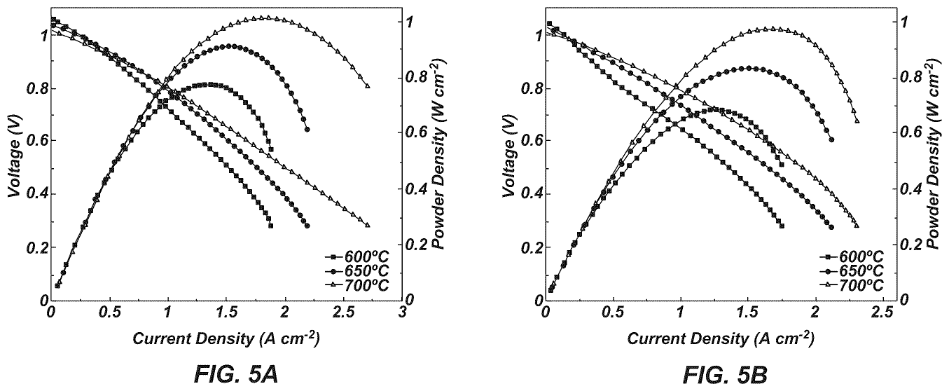

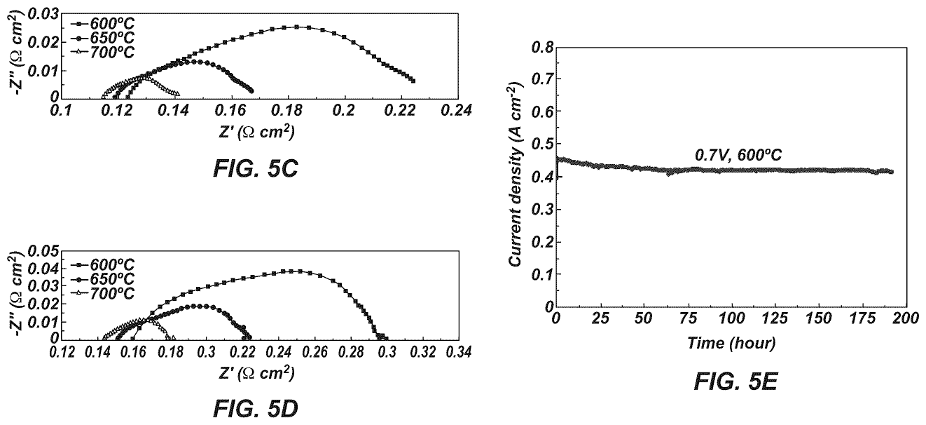

A high degree of flatness of electrochemical cells is desirable for fuel cell performance and long-term stability. Fuel cells, such as anode supported fuel cells, may suffer from deformation when sintered at high temperature or operated in a reduction atmosphere. This may be due to a non-symmetric cell configuration. FIGS. 4A-4F show after-sintered DEHC and SEHC cells having different shapes and sizes. When sintering, the electrochemical cells were buried in BZCYYb powder as shown in the sintering 116 act in FIG. 1. FIGS. 4A-4F illustrate top views (FIGS. 4A and 4B) and front views (FIGS. 4C and 4D) providing a view of the cell shape. From FIGS. 4A and 4C, it can be seen that the 1-inch button cell prepared with the double-sided electrolyte half-cell (DEHC, cell on left) exhibited a flat surface, while the single-sided electrolyte cell (SEHC, cell on right) exhibited a surface that bends toward the electrolyte. Without wishing to be bound by theory, it is believed that the expansion of the anode may cause the bending of the SEHC, however, the DEHC may exhibit a flat surface due to the symmetric configuration including the electrolyte/anode support layer/electrolyte. Similarly, large scale 5×5 cm² cells with single-sided and double-sided electrolyte were fabricated using the same method as the 1-inch cells. As shown in FIGS. 4B and 4D, 5×5 cm² DEHC (cell on left) exhibited a flat surface, while the SECH (cell on right) exhibited a surface that is bent towards the electrolyte side. FIG. 4E shows a three-dimensional (3D) height profiling map of a DEHC. FIG. 4F shows a 3D high profiling map of a SEHC.

### Physical and Chemical Stability During Electrochemical Operation

PNC was reported as a triple conducting oxide, exhibiting a good compatibility with the electrolyte. PNC was applied to the DEHC and SEHC to determine the cell performance. For DEHC, one side of the electrolyte was polished to remove one of the electrolyte layers before the cathode was disposed on the remaining electrolyte layer. Then, the PNC was screen-printed on the remaining electrolyte layer. The corresponding fuel cells with PNC as cathode were characterized at about 600° C. to about 700° C. using 3% H₂O—H₂ as fuel at the anode with a 20 mL/minute flow rate and stationary air as oxidant at the cathode, respectively. FIG. 5A shows the I-V (current voltage) and I-P (ingress protection) characteristics of the DEHC when operating at various temperatures. The open circuit voltages (OCVs) were 1.04 V, 1.02 V, 1.01 V at 600° C., 650° C., 700° C., respectively. The OCV results demonstrated a dense enough electrolyte layer and good sealing. Maximum power densities (MPDs) of the cell are 0.77 W cm⁻² at 600° C., 0.91 W cm⁻² at 650° C., 1.01 W cm⁻² at 700° C., respectively. At the same time, the performance of the conventional SEHC was also characterized. As shown in FIG. 5B, the SEHCs also exhibited reasonable OCVs at 1.03 V, 1.01 V, 1 V at 600° C., 650° C., 700° C., respectively. The MPDs of the cell were 0.68 W cm⁻² at 600° C., 0.83 W cm⁻² 650° C., 0.97 W cm⁻² at 700° C., respectively.

Area specific resistance data for DEHC and SEHC is shown in Table 1.

TABLE 1
Area specific resistance R_{Ω} and Rₚ for DEHC and SEHC at various
temperatures (via current interruption measurements)

| Temperature | DEHC | | SEHC | |
|---|---|---|---|---|
| (° C.) | R_{Ω} (Ω cm²) | Rₚ (Ω cm²) | R_{Ω} (Ω cm²) | Rₚ (Ω cm²) |
| 600 | 0.123 | 0.101 | 0.159 | 0.141 |
| 650 | 0.118 | 0.049 | 0.151 | 0.069 |
| 700 | 0.114 | 0.027 | 0.143 | 0.035 |

The impedance spectra in Nyquist plots at open circuit in wet H₂ (3% H₂O) from 600° C. to 700° C. of DEHC and SEHC are depicted in FIG. 5C and FIG. 5D. The ohmic resistances (Rₒₕₘ) of DEHC were obtained from the high-frequency intercepts of the impedance spectra, which were 0.123 Ω cm², 0.118 Ω cm², and 0.114 Ω cm² at 600° C., 650° C., and 700° C., respectively. An activation energy (0.36±0.01 eV) was nearly identical to that of bulk BZCYYb4411 under the humidified H₂ conditions (0.35±0.03 eV) within error. The polarization resistance of the electrodes (Rp) was determined from the difference between the high- and low-frequency intercepts with the real axis. The Rp values of the DEHC were determined to be 0.101 Ω cm², 0.049 Ω cm², and 0.027 Ω cm² at 600° C., 650° C., and 700° C., respectively. FIG. 5E shows cell performance stability test results for the DEHC at a constant voltage 0.7 V at 600° C.

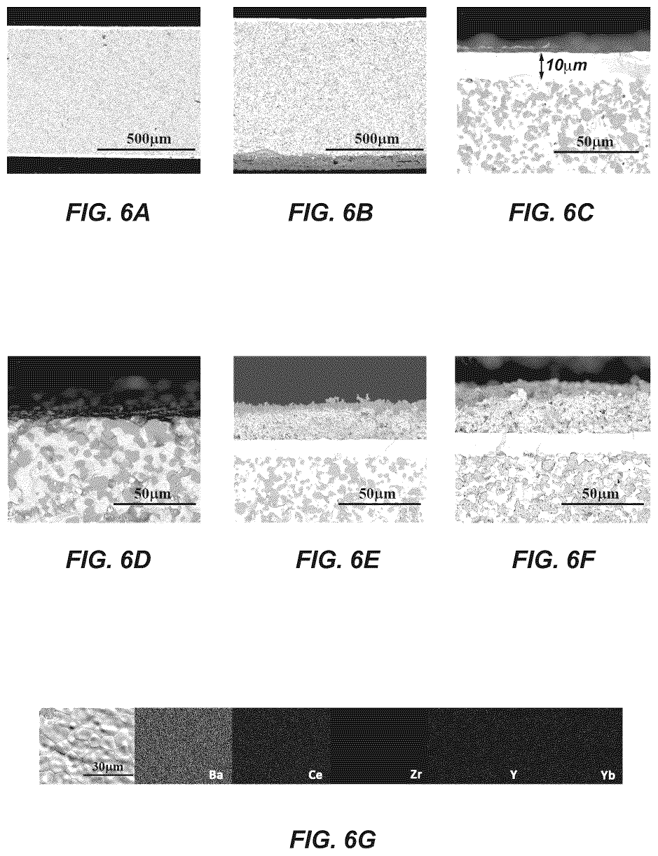

FIGS. 6A and 6B show cross sections of SEHC and DEHC, respectively. FIG. 6C is an enlarged view of the electrolyte and anode support layer. FIG. 6D shows the anode support layer after removing one side of electrolyte from DEHC by polishing for 2 seconds. FIGS. 6E and 6F show DEHC cross section with cathode, electrolyte, and ASL before (FIG. 6E) and after (FIG. 6F) the cell performance test. FIG. 6G is an energy dispersive X-ray spectrograph (EDX) of the double-sided electrolyte surface.

SEM analysis was performed to observe the electrolyte surface and cell cross section. FIGS. 6A and 6B show the cross-section of DEHC and SEHC, respectively. For both DEHCs and SEHCs, the ASL is about 700 m, and the electrolyte is about 10 m, as shown in FIG. 6C, which is an enlarged view of the electrolyte in FIG. 6B. As described, for single cell fabrication and testing, one side of electrolyte in DEHC was removed. FIG. 6D shows the bare ASL after polishing the electrolyte (to remove) on a polishing machine for 2 seconds using a 300 spin speed and 400 mesh abrasive paper. FIG. 6E shows the cross-section of the fresh single cell before the electrochemical test, of which an about 20 m porous cathode had a good contact with the about 10 m dense electrolyte, and the ASL exhibited as grayer NiO and white BZCYYb4411. After cell electrochemical performance and long-term stability testing, the cross section of the cell is shown in FIG. 6F.

FIG. 6F shows the micro-morphology and the elements distribution on the BZCYYb4411 electrolyte surface of the DEHC. The grains are well developed with the largest size being about 15 μm, and the grain boundaries were evident. EDX results show the BZCYYb4411 electrolyte surface had uniform elements distribution without any other containment, such as Ni from the anode support layer and/or aluminum from the container. As illustrated in FIG. 1, both the DEHC and SEHC cells were sintered by burying them in BZCYYb electrolyte powder 117. This strategy provided an environment of electrolyte powder around the cells and may provide benefits to the cell sintering. The process avoided the exposure of the cells to air directly, which may reduce Ba volatilization when sintering at a high temperature. During BZCY cell sintering, Ba may vaporize at high temperature and thus may lead to insufficient Ba in the BZCY electrolyte, which may affect electrolyte proton conductivity. The method, according to embodiments of the disclosure, may avoid the cell directly contacting the sintering substrate, such as Al₂O₃, which may avoid BCZY reacting with the sintering substrate.

Thus, a flat PCEC with a symmetric half-cell configuration and anode-supported structure (DEHC) was prepared. Tape casting, lamination, and sintering acts were employed to prepare the anode-supported PNC/Ni-BZCYYb4411/BZCYYb4411 cells. The resulting half-cell including the BZCYYb4411/Ni-BZCYYb4411/BZCYYb4411 structure resulted in a full cell having a flat surface, such as shown with the 1-inch cell described herein. The method, according to embodiments of the disclosure, is applicable to larger 5×5 cm² cells. The full cells fabricated with the double-sided electrolyte half-cell showed an improvement in OCV and electrochemical performance. The power density output at 700° C. reached 1.01 W cm⁻² and the long-term operational stability was nearly 200 hours.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

What is claimed is:

1. A method for forming an electrochemical device, comprising:
forming a first electrolyte layer on a first electrode;
forming a second electrolyte layer on the first electrode, the first electrode positioned between the first electrolyte layer and the second electrolyte layer, and a chemical composition and a thickness of the first electrolyte layer and the second electrolyte layer being substantially the same;
heating the first electrolyte layer and the second electrolyte layer;
removing the first electrolyte layer;
forming a second electrode on the second electrolyte layer; and
heating the second electrode to form an electrochemical device.

2. The method of claim 1, wherein forming an electrochemical device comprises forming a proton-conducting electrochemical cell, forming an oxygen-ion-conducting electrochemical cell, or forming a solid state lithium battery.

3. The method of claim 1, wherein forming an electrochemical device comprises forming a planar electrochemical cell.

4. The method of claim 1, wherein heating the first electrolyte layer and the second electrolyte layer and removing the first electrolyte layer forms a half-cell exhibiting one or more of a flat surface, a smooth surface, a surface that is substantially free of defects, and a surface that is substantially free of impurities.

5. The method of claim 1, wherein forming a first electrolyte layer on a first electrode comprises forming a first electrolyte layer on a hydrogen electrode or forming a first electrolyte layer on an oxygen electrode.

6. The method of claim 1, wherein forming a first electrolyte layer on a first electrode comprises forming a first electrolyte layer on an anode.

7. The method of claim 1, wherein forming a first electrolyte layer on a first electrode comprises forming the first electrolyte layer on an anode support layer, the anode support layer comprising a support layer material and an anode material on the support layer material.

8. The method of claim 1, wherein heating the first electrolyte layer and the second electrolyte layer comprises heating with the first electrolyte layer, the first electrode, and the second electrolyte layer immersed in an electrolyte powder.

9. The method of claim 1, wherein heating the first electrolyte layer and the second electrolyte layer comprises heating the first electrolyte layer and the second electrolyte layer at a first temperature and, subsequently, heating the first electrolyte layer and the second electrolyte layer at a second temperature wherein the second temperature is higher than the first temperature.

10. The method of claim 9, wherein the first temperature comprises a temperature of from about 600° C. to about 1100° C., and wherein the second temperature comprises a temperature of from about 1300° C. to about 1600° C.

11. The method of claim 1, wherein removing the first electrolyte layer comprises one or more of chemically removing the first electrolyte layer and physically removing the first electrolyte layer.

12. The method of claim 1, wherein forming the first electrolyte layer and forming the second electrolyte layer comprises forming the electrolyte layers comprising barium zirconate, yttrium doped barium zirconate, ytterbium doped barium zirconate, iron doped barium zirconate, cobalt doped barium zirconate, samarium doped barium zirconate, zinc doped barium zirconate, hafnium doped barium zirconate, strontium doped barium zirconate, lanthanum doped barium zirconate, calcium doped barium zirconate, barium cerate, yttrium doped barium cerate, ytterbium doped barium cerate, iron doped barium cerate, cobalt doped barium cerate, samarium doped barium cerate, zinc doped barium cerate, hafnium doped barium cerate, strontium doped barium cerate, lanthanum doped barium cerate, or calcium doped barium cerate.

13. The method of claim 1, wherein forming the first electrolyte layer and forming the second electrolyte layer comprises forming the electrolyte layers comprising ceria, yttrium doped ceria, scandium doped ceria, cerium doped ceria, gadolinium doped ceria, strontium doped ceria, magnesium doped ceria, zirconia, yttrium doped zirconia, scandium doped zirconia, cerium doped zirconia, gadolinium doped zirconia, strontium doped zirconia, magnesium doped zirconia, cerium zirconium oxide, yttrium doped cerium zirconium oxide, scandium doped cerium zirconium oxide, cerium doped cerium zirconium oxide, gadolinium doped cerium zirconium oxide, strontium doped cerium zirconium oxide, magnesium doped cerium zirconium oxide, lanthanum gallate, yttrium doped lanthanum gallate, scandium doped lanthanum gallate, cerium doped lanthanum gallate, gadolinium doped lanthanum gallate, strontium doped lanthanum gallate, or magnesium doped lanthanum gallate.

14. The method of claim 1, wherein forming the first electrolyte layer and forming the second electrolyte layer comprises forming the electrolyte layers comprising lithium lanthanum oxide, niobium doped lithium lanthanum oxide, tantalum doped lithium lanthanum oxide, barium doped lithium lanthanum oxide, or zirconium doped lithium lanthanum oxide.

15. The method of claim 1, wherein forming a first electrolyte layer on a first electrode comprises forming a first electrolyte layer on an anode support layer, the anode support layer comprising a support layer material and an anode material thereon;
wherein forming a second electrolyte layer on the first electrode comprises forming a second electrode layer on the anode support layer, the anode support layer positioned between the first electrolyte layer and the second electrolyte layer;
wherein heating the first electrolyte layer and the second electrolyte layer comprises sintering the first electrolyte layer and the second electrolyte layer;
wherein forming a second electrode on the second electrolyte layer comprises forming a cathode layer on the second electrolyte layer; and
wherein heating the second electrode to form an electrochemical device comprises sintering the cathode layer to form an electrochemical device.

16. The method of claim 15, wherein forming an electrochemical device comprises forming a planar proton-conducting electrochemical cell, forming a planar oxygen-ion-conducting electrochemical cell, or forming a solid state lithium battery.

17. The method of claim 15, wherein sintering the first electrolyte layer and the second electrolyte layer comprises heating the first electrolyte layer and the second electrolyte layer at a first temperature and, subsequently, heating the first electrolyte layer and the second electrolyte layer at a second temperature wherein the second temperature is higher than the first temperature.

18. The method of claim 15, wherein sintering the first electrolyte layer and the second electrolyte layer comprises sintering with the first electrolyte layer, first electrode, and second electrolyte layer immersed in an electrolyte powder.

19. A method for forming a planar proton conducting electrochemical cell, comprising:
forming a first electrolyte layer on an anode layer;
forming a second electrolyte layer on the anode layer, the anode layer positioned between the first electrolyte layer and the second electrolyte layer, and a chemical composition and a thickness of the first electrolyte layer and the second electrolyte layer being substantially the same;
heating the first electrolyte layer and the second electrolyte layer;
removing the first electrolyte layer;
forming a cathode layer on the second electrolyte layer; and
heating the cathode layer to form a planar proton conducting electrochemical cell.

20. An electrochemical device comprising:
an electrolyte layer on a first electrode; and
a second electrode on the electrolyte layer, the electrolyte layer positioned between the first electrode and the second electrode,
the electrochemical device exhibiting a substantially flat surface having a surface variation of less than about 50 micrometers.
